(19) United States
(12) Patent Application Publication
(10) Pub. No.: US 2009/0010734 A1
(43) Pub. Date: Jan. 8, 2009

(54) SCREW

(75) Inventor: CHING-KUEI LIN, KAOHSIUNG COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: CHANNG CHIN INDUSTRY CORP., KAOHSIUNG (TW)

(21) Appl. No.: 12/185,275

(22) Filed: Aug. 4, 2008

Related U.S. Application Data
(63) Continuation-in-part of application No. 11/376,223, filed on Mar. 16, 2006.

(51) Int. Cl. F16B 35/04

(52) U.S. Cl. 411/413

(57) ABSTRACT

The present invention pertains to a screw including a head, a shank having a first clockwise-threaded section and a counterclockwise-threaded section, and a drilling portion with a bottom end. Particularly, the counterclockwise-threaded section spiraling downward from the head connects to the first clockwise-threaded section by concurrently engaging their respective thread ends together. Therefore, the present invention applies the convergence of the two thread ends to efficiently guide the debris cutting by the first clockwise-threaded section and the counter force of the counterclockwise-threaded section to squeeze the debris back and share it among the threaded sections during the gradual travel of the shank through the articles, thereby reducing the drilling resistance and saving the labor imparting to the screw. Furthermore, the clockwise and the counterclockwise sections also counterbalance to steadily keep the screw buried in the articles without loosening.

### CROSS-REFERENCE TO RELATED APPLICATION

This application is a continuation-in-part of the U.S. patent application Ser. No. 11/376,223, filed on Mar. 16, 2006, the subject matter is incorporated herein by reference in its entirety.

### BACKGROUND OF THE INVENTION

1. Field of the Invention

The present invention relates to a screw structure, particularly to a screw able to save labor and to be stably screwed into articles without being easily loosened off.

2. Description of the Related Art

Usually, a conventional screw is used to keep non-metallic articles that are made plastics, wood, or other materials (namely composite articles), fastened together via screwing it directly into them. By means of the screw harder than the articles, it performs in squeezing and forming threaded grooves inside those articles to keep the articles tightly fastened together while positioning the screw therein. However, while the conventional screw is gradually screwed into articles, a counter force is relatively caused by the articles to be against the screw since the screw merely squeezes the articles but does not proceed cutting. So the deeper the screw is forced in, the more the contacting area and the drilling torque between the screw and the articles is increased. The user thus has to spend more labor and more time on entirely drilling the conventional screw into articles.

The prior art includes a screw for screwing into the composite articles, disclosed by Su in U.S. Patent Application Publication No.2007/0128001, which has two opposite threaded portions on the shank, namely a right-hand and a left-hand threaded portion, divided by a non-thread transition section providing with a larger diameter than that of the shank. The prior art further presents that right-hand threaded portion has a greater outer diameter and a smaller flank angle than those of the left-hand threaded portion to achieve the cutting capability.

Prior to Su's Application, the U.S. Pat. No. 4,653,244 by Farrell, U.S. Pat. No. 6,941,635 by Craven, and U.S. Pat. No. 7,037,059 by Dicke, also teach two opposite threaded sections with opposite pitches (shown in his FIG. 3) that are separated by a thread-free section whose diameter may be larger than the root diameter of the two threaded sections.

Disclosed by Laverty, issued U.S. Pat. No. 3,861,269, is a self-tapping screw for screwing into relative wall materials which includes a shank having an upper threaded portion and a lower threaded portion, and the lower threaded portion includes threads having a smaller uniform pitch and located therebetween to define parallel twin threads for drilling into the materials.

Furthermore, a screw for entry to a pre-drilled pilot hole of the workpiece disclosed by Fukubayashi U.S. Pat. No. 5,044,855 mainly comprises a shank separated by three portions; wherein, the first is gradually and progressively changed and converted from an arcuate triangular cross-sectional shape at its two lower portions to a round shape at its upper portion adjacent to a screw head.

The screws of the above prior arts may essentially disclose to obtain the goals of rapid screwing by having a cutting capability for a less driving torque and of steadily positioning screws into the articles. The screws of Su, Farrell, Craven, and Dicke herein are believed as the closest known prior arts. Both of them mainly apply the outer diameter and the flank angle to improve the cutting capability and make the counterbalance of the two opposite threads and the transition section for bonding the articles together. However, they do not provide the structure that concurrently includes a cutting effect and a well removal of cutting debris for the purposes of decreasing the drilling torque and saving more labor. That is, when their counterclockwise-threaded section squeeze the debris back, their non-thread sections with a larger diameter and an elongate length substantively makes obstruction in guiding the cutting debris and replaces by forcibly gathering or restricting debris among the clockwise-threaded section, which however results of a progressive increase in screwing resistance and drilling torque during the travel of the screw through the articles and even causes an abrupt fracture of the screw.

### SUMMARY OF THE INVENTION

Therefore, the objective of the present invention is to offer a screw that overcomes the deficiencies of the conventional screw and facilitates to reduce the resistance, save user's labor, and prevent the screw from being easily loosened off after screwing.

The screw in accordance with the present invention essentially comprises a head, a shank, and a drilling portion at the bottom of the shank. Wherein, the shank has a counterclockwise-threaded section spirally expending from the head, which is followed by a first clockwise-threaded sections. Wherein, the counterclockwise-threaded section incessantly continues with the first clockwise-threaded section by concurrently engaging their respective threads ends with each other. Therefore, the convergence of the threaded sections efficiently removes the debris cutting by the first clockwise-threaded section and helps the counterclockwise-threaded section that counterbalance the screwing force squeeze and distribute the debris equally among the two threaded sections, whereby the present invention conduces to save more labor by reducing the screwing resistance and keep the screw stably buried in the articles without loosening off articles while being subjected to non-manual factors.

### BRIEF DESCRIPTION OF THE DRAWINGS

The advantages of the present invention over the known prior arts will become more apparent to those of ordinary skilled in the art by reading the following descriptions with the relating drawings.

FIG. 1 is an elevational view of a preferred embodiment in the present invention;

FIG. 2 is a cross-sectional view of another preferred embodiment of the present invention; and

FIGS. 3 and 4 are top views showing the screw head of the present invention.

### DETAILED DESCRIPTION OF THE PREFERRED EMBODIMENTS

Before in greater detail, it should note that the like elements are denoted by similar reference numerals throughout the disclosure.

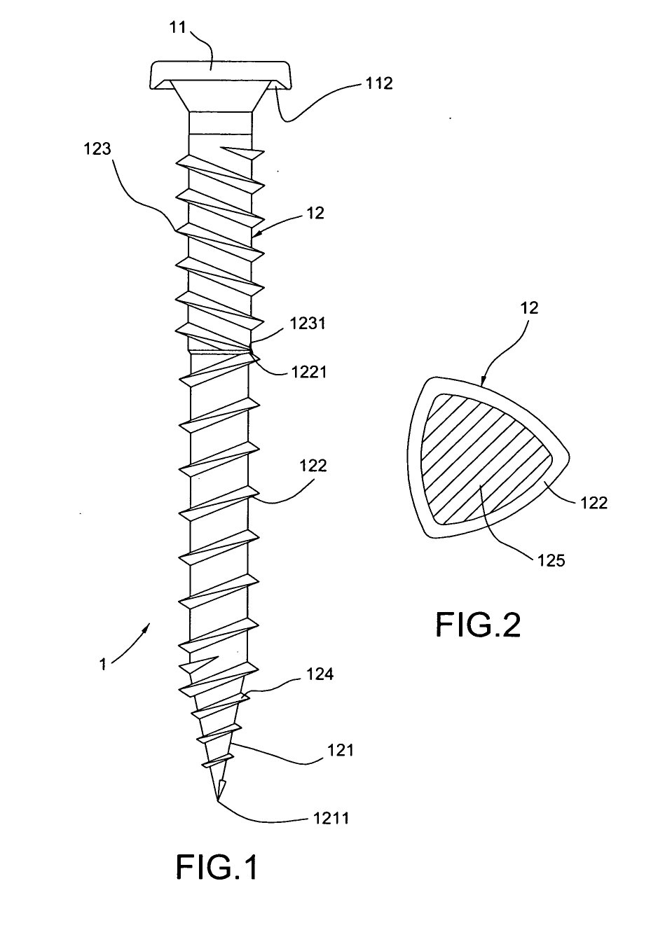

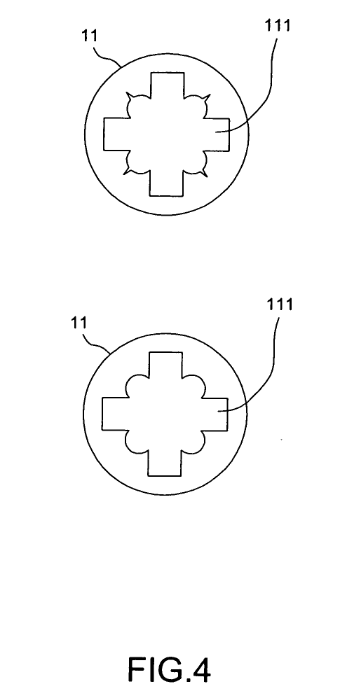

Referring to FIG. 1, a screw 1 of the first preferred embodiment includes a head 11, a shank 12 extending down from the head 11, and a drilling portion 121 formed at the bottom of the shank 12. Wherein, the head 11 has a recess 111 (shown in FIGS. 3 and 4), which can be various shapes, disposed on its top surface for receiving a tool, such as a screwdriver, to fit closely in and an annular groove 112 formed around the circumference of the bottom thereof so that the head 11 is cross-sectionally shaped as a reverse-U contour.

Still, the shank 12 is provided with a bottom end 1211 at the distal end of the drilling portion 121 that is formed of a conical sharp point, a first clockwise-threaded section 122, and a counterclockwise-threaded section 123. Wherein, the counterclockwise threaded section 123 spirals downward from the head 11, and the first clockwise-threaded section 122 follows the counterclockwise-threaded section 123 and spirals toward the drilling portion 121; in addition, a second clockwise-threaded section 124 is additionally formed on the drilling portion 121 and provided with a one-third length of the first clockwise-threaded section 122 for attaining a smaller uniform pitch. The first clockwise-threaded section 122 and the counterclockwise-threaded section 123 specifically have their respective thread ends 1221, 1231 concurrently converge at one point; that is, a terminal thread end 1231 of the counterclockwise-threaded section 123 engages to an initial thread end 1221 of the first clockwise-threaded section 123, thereby permitting the first clockwise-threaded section 122 to incessantly connect with the counterclockwise-threaded section 123. Also, the counterclockwise-threaded section 123 has an outer diameter and an inner diameter alternatively greater than or equal to those of the first clockwise-threaded section 122. Herein it is adopted in FIG. 1 that the counterclockwise-threaded section has greater outer and inner diameters.

In using, superpose wooden or non-metallic articles (not shown) on each other to become composite articles first. Next, keep the conical sharp point 1211 of the screw 1 positioned vertically on the surface of an upper article and rotarily motivate the sharp point 1211 to be screwed and drilled through the articles. By virtue of the second clockwise-threaded section 124 having a smaller pitch for initially cutting debris, the screw 1 smoothly enters into the articles.

Further, during the travel from the first clockwise-threaded section 122 toward the counter clockwise-threaded section 123 through the articles, the cutting debris is thence smoothly guided and removed along the track of the convergence of the terminal thread end 1221 and the terminal thread end 1231, which hence attains the diminution of the resistant force in time of drilling to assist in easily and rapidly drilling the screw 1 into the articles without imparting much labor. Thereafter, the counterclockwise-threaded section 123 counteracts the screwing force from the articles and in turn squeezes the debris back to share it among those threaded sections through the aforementioned convergence of the thread ends 1221, 1231, whereby the screw 1 can firmly position itself within the articles. Moreover, while the shank 12 of the screw 1 is wholly engaged into the articles, the annular groove 112 is forcefully filled with a part of the upper article, so that both edges of the head 11 can therefore be stably inserted into the surface of the upper article for achieving a better screwing effect.

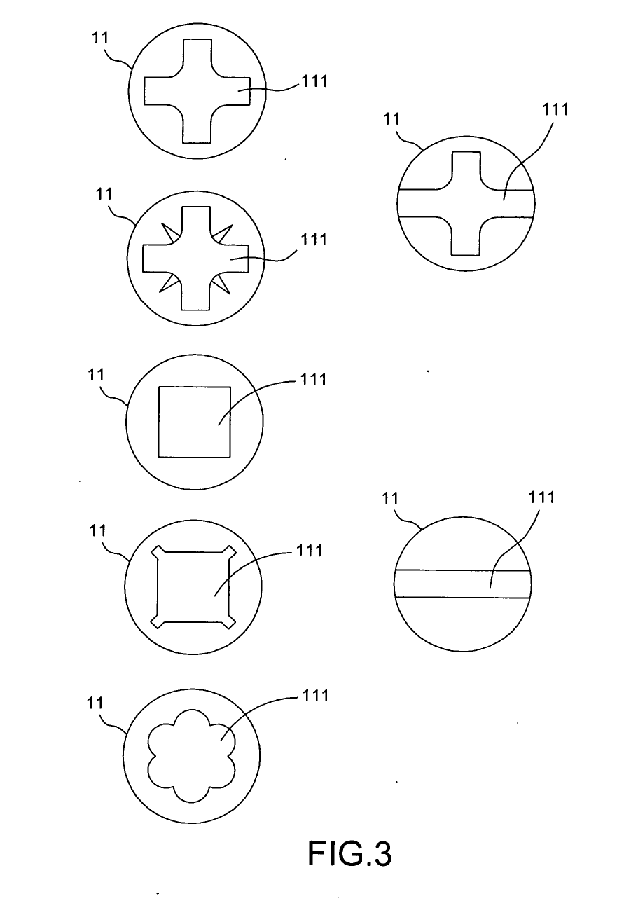

As shown in FIG. 2, the second preferred embodiment of the present invention still has the structures as the same as the first embodiment. Particularly, the shank 12 extends with a substantially triangular contoured cross-section 125 from the head 11; furthermore, the first clockwise-threaded section 122, the counterclockwise-threaded section 123, and the second clockwise-threaded section 124 are all shaped triangular for rendering their threads to merely contact with respect to the articles by three points, which more decreasing the resistant force caused by articles to be screwed together.

Thus, the present invention comes with following advantages:
1. The screw 1 is screwed into articles easily and rapidly because the first clockwise-threaded section 122 or the smaller pitch of the second clockwise-threaded section 124 designs for quickly cutting debris and the convergence of the two thread ends 1221, 1231 helps remove the debris efficiently and equally distribute the debris among those threaded sections for decreasing the screwing resistance and drilling torque.
2. The shanks 12 keeps three points contacting with the articles when it performs in a cross-sectionally triangular contour 125, thereby more decreasing the resistant force caused by the articles for a quicker screwing.
3. The threaded sections of the shank 12 are able to counterbalance with each other, namely the first and second clockwise-threaded sections 122,124 and the counterclockwise-threaded section 123 receive a one-way vibration. Wherein, the first and second clockwise-threaded sections 122,124 are to be screwed outward, but the counterclockwise-threaded section 123 is to be screwed inward to counterbalance the screwing force of the first and the second clockwise-threaded sections 122,124 and to squeeze back the cutting debris, thereby preventing the screw 1 from being easily disengaged from or loosened off the articles.
4. When the shank 12 of the screw 1 is entirely drilled into the articles, the annular groove 112 and both edges of the head 11 are forcefully and integrally embedded into the upper article for achieving a better securing effect.

To sum up, the present invention takes advantages of a shank with the opposite threaded sections, of which their respective thread ends are arranged to connect with each other. By means of the initial cutting of the clockwise-threaded section and the debris guidance by the convergence of the above thread ends, the screw can be readily screwed into the composite articles. Accompanying with the counterclockwise-threaded section to counterbalance the screwing force and equally squeeze the debris among the threaded sections under the assistance of the convergence, the present invention hence not only attains an easy entry into the articles without imparting too much labor but also stably drills the screw into the articles to avoid the problem of loosening. Furthermore, the present invention can also have the substantially triangular shank and thread sections for more decreasing the resistance force while in use.

While the preferred embodiment of the invention has been described above, it will be recognized and understood that various modifications may be made therein and the appended claims are intended to cover all such modifications that may not depart from the spirit and the scope of the invention.

I claim:

1. A screw comprising:
a head;
a shank extending from said head and including a counterclockwise-threaded section and a first clockwise-threaded section spirally disposed thereon; and
a drilling portion, disposed at the bottom of said shank, defining a bottom end disposed at its distal end;
wherein, said counterclockwise-threaded section spiraling downward from said head, and said first clockwise-threaded section following said counterclockwise-threaded section to be helically extended toward said drilling portion; said counterclockwise-threaded section having a terminal thread end directly engaging to an initial thread end of said first clockwise-threaded section so as to converge said two threaded sections at one point.

2. The screw as claimed in claim 1, wherein, a second clockwise-threaded section are helically located on said drilling portion and comprised of a smaller uniform pitch than that of said first clockwise-threaded section.

3. The screw as claimed in claim 1, wherein, said shank extends with a substantially triangular contoured cross-section from said head.

4. The screw as claimed in claim 1, wherein, said counterclockwise-threaded section has an outer diameter and an inner diameter greater than those of said first clockwise-threaded section.

5. The screw as claimed in claim 1, wherein, said counterclockwise-threaded section has an outer diameter and an inner diameter equal to those of said first clockwise-threaded section.

6. The screw as claimed in claim 1, wherein said head is provided with an annular groove formed around the circumference of its bottom.

7. The screw as claimed in claim 1, wherein said drilling portion is formed of a conical sharp point.

8. The screw as claimed in claim 2, wherein said first clockwise-threaded section, said second clockwise-threaded section, and said counterclockwise-threaded section are all shaped triangular.
